(19) United States
(12) Patent Application Publication
(10) Pub. No.: US 2013/0269719 A1
(43) Pub. Date: Oct. 17, 2013

(54) METHOD FOR TREATING PLANTS WITH PROBIOTICS

(71) Applicants: Jerry Wayne Marshall, Stokesdale, NC (US); Serban C. Moldoveanu, Winston-Salem, NC (US); Michael F. Davis, Clemmons, NC (US); Marvin Glenn Riddick, Winston-Salem, NC (US)

(72) Inventors: Jerry Wayne Marshall, Stokesdale, NC (US); Serban C. Moldoveanu, Winston-Salem, NC (US); Michael F. Davis, Clemmons, NC (US); Marvin Glenn Riddick, Winston-Salem, NC (US)

(73) Assignee: R.J. Reynolds Tobacco Company

(21) Appl. No.: 13/444,272

(22) Filed: Apr. 11, 2012

(51) Int. Cl. A24B 15/28; A24D 1/04; C12S 3/00; A24B 13/00

(52) U.S. Cl. 131/290; 131/352; 131/331; 435/267

(57) ABSTRACT

A method of modifying the content of certain chemical compounds in tobacco materials is provided, the method including treatment of a tobacco plant component with at least one probiotic. For example, the method may modify the asparagine content in tobacco materials, which can result in a modification in acrylamide production when the tobacco material is exposed to elevated temperatures. The type of tobacco plant component treated according to the invention can be a tobacco seed, a tobacco seedling, an immature live plant, a mature live plant, a harvested plant, or a portion thereof. Examples of probiotics include probiotic species of the genera bifidobacterium, lactobacillus, enterococcus, proionobacterium, bacillus, saccharomyces, streptococcus, and mixtures thereof. Smoking articles and other tobacco products including such probiotic-treated tobacco materials are also provided.

### FIELD OF THE INVENTION

The present invention relates to plants and modifications to the method of growing, harvesting, and/or treating plants (e.g., tobacco). Particularly, the present invention relates to products made or derived from tobacco, or that otherwise incorporate tobacco, and are intended for human consumption.

### BACKGROUND OF THE INVENTION

Popular smoking articles, such as cigarettes, have a substantially cylindrical rod shaped structure and include a charge, roll or column of smokable material such as shredded tobacco (e.g., in cut filler form) surrounded by a paper wrapper thereby forming a so-called “tobacco rod.” Normally, a cigarette has a cylindrical filter element aligned in an end-to-end relationship with the tobacco rod. Typically, a filter element comprises plasticized cellulose acetate tow circumscribed by a paper material known as “plug wrap.” Certain cigarettes incorporate a filter element having multiple segments, and one of those segments can comprise activated charcoal particles. Typically, the filter element is attached to one end of the tobacco rod using a circumscribing wrapping material known as “tipping paper.” It also has become desirable to perforate the tipping material and plug wrap, in order to provide dilution of drawn mainstream smoke with ambient air. A cigarette is employed by a smoker by lighting one end thereof and burning the tobacco rod. The smoker then receives mainstream smoke into his/her mouth by drawing on the opposite end (e.g., the filter end) of the cigarette.

The tobacco used for cigarette manufacture is typically used in blended form. For example, certain popular tobacco blends, commonly referred to as “American blends,” comprise mixtures of flue-cured tobacco, burley tobacco and Oriental tobacco, and in many cases, certain processed tobaccos, such as reconstituted tobacco and processed tobacco stems. The precise amount of each type of tobacco within a tobacco blend used for the manufacture of a particular cigarette brand varies from brand to brand. However, for many tobacco blends, flue-cured tobacco makes up a relatively large proportion of the blend, while Oriental tobacco makes up a relatively small proportion of the blend. See, for example, Tobacco Encyclopedia, Voges (Ed.) p. 44-45 (1984), Browne, The Design of Cigarettes, 3^{rd} Ed., p. 43 (1990) and Tobacco Production, Chemistry and Technology, Davis et al. (Eds.) p. 346 (1999).

Tobacco also may be enjoyed in a so-called “smokeless” form. Particularly popular smokeless tobacco products are employed by inserting some form of processed tobacco or tobacco-containing formulation into the mouth of the user. Various types of smokeless tobacco products are known. See for example, the types of smokeless tobacco formulations, ingredients, and processing methodologies set forth in U.S. Pat. No. 1,376,586 to Schwartz; U.S. Pat. No. 3,696,917 to Levi; U.S. Pat. No. 4,513,756 to Pittman et al.; U.S. Pat. No. 4,528,993 to Sensabaugh, Jr. et al.; U.S. Pat. No. 4,624,269 to Story et al.; U.S. Pat. No. 4,991,599 to Tibbetts; U.S. Pat. No. 4,987,907 to Townsend; U.S. Pat. No. 5,092,352 to Sprinkle, III et al.; U.S. Pat. No. 5,387,416 to White et al.; U.S. Pat. No. 6,668,839 to Williams; U.S. Pat. No. 6,834,654 to Williams; U.S. Pat. No. 6,953,040 to Atchley et al.; U.S. Pat. No. 7,032,601 to Atchley et al.; and U.S. Pat. No. 7,694,686 to Atchley et al.; US Pat. Pub. Nos. 2004/0020503 to Williams; 2005/0115580 to Quinter et al.; 2006/0191548 to Strickland et al.; 2007/0062549 to Holton, Jr. et al.; 2007/0186941 to Holton, Jr. et al.; 2007/0186942 to Strickland et al.; 2008/0029110 to Dube et al.; 2008/0029116 to Robinson et al.; 2008/0173317 to Robinson et al.; 2008/0196730 to Engstrom et al.; 2008/0209586 to Neilsen et al.; 2008/0305216 to Crawford et al.; 2009/0065013 to Essen et al.; 2009/0293889 to Kumar et al.; 2010/0291245 to Gao et al; and 2011/0139164 to Mua et al.; PCT WO 04/095959 to Arnarp et al. and WO 2010/132444 to Atchley; each of which is incorporated herein by reference.

One type of smokeless tobacco product is referred to as “snuff” Representative types of moist snuff products, commonly referred to as “snus,” have been manufactured in Europe, particularly in Sweden, by or through companies such as Swedish Match AB, Fiedler & Lundgren AB, Gustavus AB, Skandinavisk Tobakskompagni A/S, and Rocker Production AB. Snus products available in the U.S.A. have been marketed under the tradenames Camel Snus Frost, Camel Snus Original and Camel Snus Spice by R. J. Reynolds Tobacco Company. See also, for example, Bryzgalov et al., 1N1800 Life Cycle Assessment, Comparative Life Cycle Assessment of General Loose and Portion Snus (2005). In addition, certain quality standards associated with snus manufacture have been assembled as a so-called GothiaTek standard. Representative smokeless tobacco products also have been marketed under the tradenames Oliver Twist by House of Oliver Twist A/S; Copenhagen, Skoal, SkoalDry, Rooster, Red Seal, Husky, and Revel by U.S. Smokeless Tobacco Co.; “taboka” by Philip Morris USA; Levi Garrett, Peachy, Taylor's Pride, Kodiak, Hawken Wintergreen, Grizzly, Dental, Kentucky King, and Mammoth Cave by Conwood Company, LLC; and Camel Orbs, Camel Sticks, and Camel Strips by R. J. Reynolds Tobacco Company.

Through the years, various treatment methods and additives have been proposed for altering the overall character or nature of tobacco materials utilized in tobacco products. For example, additives or treatment processes have been utilized in order to alter the chemistry or sensory properties of the tobacco material, or in the case of smokable tobacco materials, to alter the chemistry or sensory properties of mainstream smoke generated by smoking articles including the tobacco material. Various types of bacteria and other microorganisms have been added to tobacco for such purposes as reducing the content of certain chemical compounds (e.g., nitrosamines including tobacco-specific nitrosamines or “TSNAs”), nitrates, cellulosic components, and nicotine), for example, as described in U.S. Pat. No. 4,140,136 to Geiss et al.; U.S. Pat. No. 4,151,848 to Newton et al.; U.S. Pat. No. 4,308,877 to Mattina et al.; U.S. Pat. No. 4,476,881 to Gravely et al.; U.S. Pat. No. 4,556,073 to Gravely et al.; U.S. Pat. No. 4,557,280 to Gravely et al.; U.S. Pat. No. 4,566,469 to Semp et al.; U.S. Pat. No. 5,372,149 to Roth et al.; U.S. Pat. No. 7,549,425 to Koga et al.; U.S. Pat. No. 7,549,426 to Koga et al.; and U.S. Pat. No. 7,556,046 to Koga et al., which are all incorporated herein by reference.

It would be desirable in the art to provide further methods for altering the character and nature of a plant such as a tobacco plant, as well as tobacco compositions and formulations useful in smoking articles or smokeless tobacco products.

### SUMMARY OF THE INVENTION

The present invention provides a method of treating a plant or a portion thereof to modify (e.g., increase and/or decrease) the amount of certain compounds present therein. The plants to which the method of the invention can be applied can vary, and include without limitation any flowering plants or conifers, including various types of vines, trees, bushes, and other plants, such as those that bear fruit, vegetables, and legumes, as well as grains.

In one regard, the invention involves taking a plant that is used to produce a commodity, particularly a plant used as a source of food or other oral products, and treating the plant to modify the amount of certain compounds present in that part of the plant that is harvested. Such a method may result in the part of the plant that is harvested exhibiting certain taste changes, such as less bitterness. Certain specific plants to which the methods can be applied include, but are not limited to, vegetable plants such as beans (e.g., lima beans, green beans, soy beans, coffee beans), cabbage, okra, squash, lettuce, tomatoes, peppers, asparagus, celery, and the like; root and bulb vegetables (e.g., radishes, onions, garlic, and carrots); grains (e.g., wheat, barley, oats, corn, rice, rye, sorghum); fruit-bearing plants (e.g., strawberries); fruit-bearing vines (e.g., grapes, melons, and cranberries); fruit-bearing bushes (e.g., blueberries) and fruit-bearing trees (e.g., fruits such as oranges, lemons, limes, grapefruits, cherries, peaches, bananas, plantains, and apples); legumes (e.g., nuts); tea; hops; and herbs and spice plants. In certain embodiments, the method relates to tobacco.

In one aspect of the invention is provided a method for treating a plant, comprising treating the plant with one or more probiotics. In certain embodiments, the method can relate to modifying (e.g., decreasing) amino acid content in plants that may subsequently be processed into a tobacco, food or beverage product involving the application of heat (e.g., by baking, frying, or microwaving). Exemplary plants that may be processed into food products with the application of heat include, but are not limited to, cereals such as wheat and flour (e.g., for the production of breakfast cereals, biscuits, crackers, wafers, bread, crisp bread, and cookies), malt and barley (e.g., for the production of beer), potatoes (e.g., for the production of potato chips and French fries), coffee and chicory (e.g., for use in roasted coffee beverages). For example, the levels of asparagine in certain plants can be modified, which can result in an acrylamide content of the food product produced therefrom that is reduced relative to an untreated food product.

In one aspect of the invention is provided a method for treating a tobacco plant comprising treating the tobacco plant with one or more probiotics. For example, in certain embodiments, the invention relates to a method of modifying (such as by decreasing) the content of certain amino acids and tobacco-specific nitrosamines in a tobacco material, comprising contacting a tobacco plant component with one or more probiotics. The tobacco plant component can vary; for example, the tobacco plant component can be selected from the group consisting of a tobacco seed, a tobacco seedling, an immature live plant, a mature live plant, a harvested plant, or a portion of any of the above (e.g., a portion of a live plant such as only the stalk or only the leaves or a portion of the surface of the seed).

Various probiotics and mixtures thereof can be used according to the invention. In certain embodiments, the one or more probiotics are selected from the group consisting of probiotic species of the genera bifidobacterium, lactobacillus, enterococcus, proionobacterium, bacillus, saccharomyces, streptococcus, and mixtures thereof. Exemplary probiotics include, but are not limited to, bifidobacterium adolescentis, bifidobacterium animalis, bifidobacterium bifidum, bifidobacterium breve, bifidobacterium infantis, bifidobacterium lactis, bifidobacterium longum, bifidobacterium pseudocatenulatum, bifidobacterium pseudolongum, bifidobacterium sp., bifidobacterium thermophilum, lactobacillus acidophilus, lactobacillus alimentarius, lactobacillus amylovorus lactobacillus bulgaricus, lactobacillus bifidus, lactobacillus brevis, lactobacillus casei, lactobacillus caucasicus, lactobacillus crispatus, lactobacillus curvatus, lactobacillus delbruckii, lactobacillus fermentum, lactobacillus gallinarum, lactobacillus gasseri, lactobacillus helveticus, lactobacillus johnsonii, lactobacillus lactis, lactobacillus leichmannii, lactobacillus paracasei, lactobacillus plantarum, lactobacillus reuteri, lactobacillus rhamnosus, lactobacillus salivarius, lactobacillus sp., lactobacillus sporogenes, lactococcus lactis, streptococcus cermoris, streptococcus faceium, streptococcus infantis, streptococcus thermophilus, enterococcus faceium, pediococcus acidilactici, staphylococcus thermophilus, staphylococcus carnosus, staphylococcus xylosus, saccharomyces boulardii, saccharomyces cerevisiae, saccharomyces boulardii, bacillus cereus var toyo, bacillus subtilis, bacillus coagulans, bacillus licheniformis, and mixtures thereof.

In some embodiments, the one or more probiotics comprise at least one probiotic selected from the genus bifidobacterium and at least one probiotic selected from the genus lactobacillus. In some embodiments, the one or more probiotics comprise two or more probiotics selected from the genus bifidobacterium or two or more probiotics selected from the genus lactobacillus.

The method of contacting the tobacco plant component with the probiotic can vary. For example, the contacting can, in certain embodiments, comprises applying the one or more probiotics in a solution, suspension, or dispersion in water.

In some embodiments, the asparagine content of the tobacco material following the step of contacting the tobacco plant component with one or more probiotics is about 50% or less by weight, about 40% or less, about 30% or less, or about 20% or less than the asparagine content of tobacco plant components that have not been contacted with a probiotic. In other words, the tobacco component treated according to the method of the invention can exhibit a reduction in asparagine content according to any the percentages set forth above.

The method can, in some embodiments, further comprise the step of incorporating the tobacco material into a smokeless tobacco product or a smoking article. The tobacco material can be, for example, in the form of cut filler and/or in the form of a tobacco blend. In certain embodiments, the tobacco plant component comprises flue-cured tobacco, burley tobacco, Oriental tobacco, or a mixture thereof. Such a smoking article, in some embodiments, upon smoking, is characterized by an acrylamide content of mainstream smoke that is reduced relative to an untreated control smoking article. The amount of acrylamide reduction by weight in mainstream smoke can, in some embodiments, be at least about 20% as compared to an untreated control smoking article or at least about 40% as compared to an untreated control smoking article.

In a further aspect of the invention, a tobacco product containing a tobacco composition comprising a probiotic-treated tobacco is provided, such as a smoking article in the form of a cigarette or a smokeless tobacco product containing tobacco treated according to the method of the invention. In one embodiment is provided a smoking article in the form of a cigarette comprising a rod of smokable material circumscribed by a wrapping material and a filter attached to the rod at one end thereof, wherein the smokable material comprises a tobacco material pre-treated with one or more probiotics to modify (e.g., decrease) the content of asparagine and, by extension, modify the content of acrylamide formed in mainstream smoke.

### BRIEF DESCRIPTION OF THE DRAWINGS

In order to provide an understanding of embodiments of the invention, reference is made to the appended drawings, which are not necessarily drawn to scale, and in which reference numerals refer to components of exemplary embodiments of the invention. The drawings are exemplary only, and should not be construed as limiting the invention.

FIG. 1 is an exploded perspective view of a smoking article having the form of a cigarette, showing the smokable material, the wrapping material components, and the filter element of the cigarette; and

FIG. 2 is a cross-sectional view of a smokeless tobacco product embodiment, taken across the width of the product, showing an outer pouch filled with a smokeless tobacco composition of the invention.

### DETAILED DESCRIPTION OF THE INVENTION

The present invention now will be described more fully hereinafter. This invention may, however, be embodied in many different forms and should not be construed as limited to the embodiments set forth herein; rather, these embodiments are provided so that this disclosure will be thorough and complete, and will fully convey the scope of the invention to those skilled in the art. As used in this specification and the claims, the singular forms “a,” “an,” and “the” include plural referents unless the context clearly dictates otherwise. Reference to “dry weight percent” or “dry weight basis” refers to weight on the basis of dry ingredients (i.e., all ingredients except water).

The invention provides plant materials having modified levels of certain compounds. In one exemplary aspect, the invention provides tobacco having modified levels of certain compounds, tobacco products incorporating tobacco material derived from such tobacco, and methods for preparing a tobacco having modified levels of certain compounds and for incorporating tobacco material derived from this tobacco within tobacco products. The method of modifying levels of certain compounds generally comprises contacting tobacco with one or more probiotics. It is noted that although the discussion provided herein focuses in large part on treatment of tobacco, a variety of other plants (including fruits, vegetables, flowers, and components thereof) can be treated according to the methods provided herein to afford plants and/or plant components having modified levels of certain compounds therein.

The probiotic treatment described herein can have various effects on the resulting tobacco material. For example, in certain embodiments, tobacco treated with one or more probiotics exhibits modified levels of certain chemical compounds. These changes can result in modification of the organoleptic properties of the tobacco, such as changes in taste or aroma (e.g., reduced bitterness or smoother flavor). It is noted that the specific results obtained may be related, in part, to the probiotic species that are used in the treatment. It is believed that probiotics of different genera, species, and/or subspecies have different effects on the levels of various compounds within the tobacco.

In one specific embodiment, tobacco is treated with probiotics to modify (e.g., reduce) the concentration of amino acids and certain other components of the tobacco. Certain amino acids and amino acid derivatives that may be modified in certain embodiments of the present invention include, but are not limited to, asparagine, tryptophan, oxoproline, and aspartic acid. One exemplary amino acid that may be advantageously reduced is asparagine. Asparagine is a precursor of acrylamide and by reducing the levels of asparagine in tobacco, the acrylamide level in smoke from a cigarette comprising such a tobacco can be decreased. Additionally, reducing asparagine content in tobacco used in smokeless tobacco products can reduce the amount of acrylamide produced in any heat treatment process (e.g., pasteurization) applied to the tobacco. In one embodiment, treatment of tobacco with one or more probiotics may result in an asparagine content that is less than about 50% by weight of that of an untreated tobacco, less than about 40% that of an untreated tobacco, less than about 30% that of an untreated tobacco, or less than about 20% that of an untreated tobacco. For example, a probiotic treated tobacco material may have between about 0% and about 70% by weight, such as between about 5% and about 60%, and advantageously between about 10% and about 40% the asparagine content of an untreated tobacco material.

Correspondingly, in certain embodiment, use of a probiotic treated tobacco can provide a smoking material that exhibits decreased acrylamide levels in the smoke produced therefrom. For example, in certain embodiments, the acrylamide level in the smoke produced from a tobacco comprising 100% probiotic-treated tobacco exhibits an acrylamide reduction of about 10% or more, about 20% or more, about 30% or more, about 40% or more, about 50% or more, about 60% or more by weight as compared with a control cigarette comprising 100% tobacco that was not probiotic-treated. Further, use of a probiotic-treated tobacco in a smokeless tobacco product can provide a product with decreased acrylamide levels. Probiotic-treated tobacco may be particularly useful in products that are heat treated at any stage of processing and/or use.

In one specific embodiment, tobacco is treated with probiotics to modify (e.g., reduce) the concentration of tobacco-specific nitrosamines (TSNAs) in the tobacco. Exemplary TSNA compounds include N-nitrosonornicotine (NNN), 4-methyl-N-nitrosamino-1-(3-pyridyl)-1-butanone (NNK), N-nitrosoanatabine (NAT), 4-methyl-N-nitrosamino-1-(3-pyridyl)-1-butanol (NNAL), and N-nitrosoanabasine (NAB). In one embodiment, treatment of tobacco with one or more probiotics may result in a NNN content that is less than about 60% by weight as compared to an untreated tobacco, or less than about 50% that of an untreated tobacco. In one embodiment, treatment of tobacco with one or more probiotics may result in a NAT content that is less than about 70% by weight as compared to an untreated tobacco, or less than about 60% that of an untreated tobacco.

In certain embodiments, the levels of other compounds in tobacco can be modified by treatment of the tobacco with probiotics. Exemplary compounds that are reduced in some embodiments include, but are not limited to, acylonitrile, malic acid, quinic acid, and glucose. The decrease in these and other compounds can vary but generally, a treated tobacco will comprise between about 10% and about 90% by weight of each such compound as compared with the amount of compound present in the untreated tobacco.

As used herein, the term “probiotic” or “probiotic microorganism” is intended to encompass all live microorganisms that may be classified as probiotics by various sources. For example, the Food and Agriculture Organization of the United Nations (FAO) defines probiotics as “live microorganisms, which, when administered in adequate amounts, confer a health benefit on the host.” In some reports, such health benefits can include, but are not limited to: colonization of the intestinal, respiratory, and/or urogenital tracts, cholesterol metabolism, lactose metabolism, absorption of calcium, synthesis of vitamins, reduction of yeast and vaginal infections, reduction of digestive problems (e.g., constipation and diarrheal diseases), production of natural antibiotics, lactic acid, enzymes, hydrogen peroxide, inhibition of pathogenic microorganisms by production of antibiotic-like substances; and a decrease in pH. Although the traditional definition of “probiotic” relates to human and animal digestive organisms, this term has been applied in other contexts, such as in the field of agriculture. Certain types of probiotics and compositional ingredients that can be added include examples set forth in U.S. Pat. No. 8,097,245 to Harel et al.; U.S. Pat. No. 8,097,281 to Heim et al.; U.S. Pat. No. 8,101,167 to Gueniche; and U.S. Pat. No. 8,101,170 to Plail et al., which are all incorporated herein by reference.

It is preferred that probiotics used according to the invention are “GRAS” (Generally Regarded as Safe), although non-GRAS probiotics can be used in certain embodiments. Probiotics are typically identified by their genus, species, and strain level. Certain recognized probiotic genera include bifidobacterium, lactobacillus, enterococcus, proionobacterium, bacillus, saccharomyces, and streptococcus. Many common probiotics are selected from lactobacillus species, bifidobacterium species, and streptococcus thermophilus.

Exemplary probiotics include, but are not limited to, bifidobacterium adolescentis, bifidobacterium animalis, bifidobacterium bifidum, bifidobacterium breve, bifidobacterium infantis, bifidobacterium lactis, bifidobacterium longum, bifidobacterium pseudocatenulatum, bifidobacterium pseudolongum, bifidobacterium sp., bifidobacterium thermophilum, lactobacillus acidophilus, lactobacillus alimentarius, lactobacillus amylovorus lactobacillus bulgaricus, lactobacillus bifidus, lactobacillus brevis, lactobacillus casei, lactobacillus caucasicus, lactobacillus crispatus, lactobacillus curvatus, lactobacillus delbruckii, lactobacillus fermentum, lactobacillus gallinarum, lactobacillus gasseri, lactobacillus helveticus, lactobacillus johnsonii, lactobacillus lactis, lactobacillus leichmannii, lactobacillus paracasei, lactobacillus plantarum, lactobacillus reuteri, lactobacillus rhamnosus, lactobacillus salivarius, lactobacillus sp., lactobacillus sporogenes, lactococcus lactis, streptococcus cermoris, streptococcus faceium, streptococcus infantis, streptococcus thermophilus, enterococcus faceium, pediococcus acidilactici, staphylococcus thermophilus, staphylococcus carnosus, staphylococcus xylosus, saccharomyces boulardii, saccharomyces cerevisiae, saccharomyces boulardii, bacillus cereus var toyo, bacillus subtilis, bacillus coagulans, and bacillus licheniformis.

Advantageously, the probiotic composition used according to the invention is a mixture of one or more probiotics. Probiotics that may be used according to the invention may comprise blends of one or more genus, species, and/or strain, which may, in certain embodiments, have improved functionality as compared with a single strain and/or species.

According to the invention, one or more probiotics can be applied to one or more plants. In particular, they may be applied to one or more plant components (e.g., tobacco plant components). By “tobacco”, “tobacco plant” or “tobacco plant components” is meant tobacco at various stages of the plant life cycle. For example, the one or more probiotics can, in certain embodiments, be applied to a seed, seedling, unharvested plant (at varying stages of maturity), or harvested plant, which are all considered to be stages of the tobacco plant as described in further detail herein. The term “plant” and “plant component” similarly relates to a plant (e.g., a plant that produces a commodity) at various stages of the plant life cycle. Thus, in certain embodiments, the one or more probiotics can be applied to a seed, seedling, unharvested plant (at varying stages of maturity), or harvested plant comprising any type of plant, such as those described herein. The commodity produced from that plant may comprise any portion of the plant (e.g., the leaf, vegetable, fruit, flower, seed, stalk, or entire plant) and thus, various portions of the plant can exhibit modified levels of certain compounds as a result of probiotic treatment according to the methods provided herein.

Tobacco or tobaccos to which the method provided herein is applicable can vary. In certain embodiments, tobaccos that can be employed include flue-cured or Virginia (e.g., K326), burley, sun-cured (e.g., Indian Kurnool and Oriental tobaccos, including Katerini, Prelip, Komotini, Xanthi and Yambol tobaccos), Maryland, dark, dark-fired, dark air cured (e.g., Passanda, Cubano, Jatin and Bezuki tobaccos), light air cured (e.g., North Wisconsin and Galpao tobaccos), Indian air cured, Red Russian and Rustica tobaccos, as well as various other rare or specialty tobaccos and various blends of any of the foregoing tobaccos. Descriptions of various types of tobaccos, growing practices and harvesting practices are set forth in Tobacco Production, Chemistry and Technology, Davis et al. (Eds.) (1999), which is incorporated herein by reference. Various representative other types of plants from the Nicotiana species are set forth in Goodspeed, The Genus Nicotiana, (Chonica Botanica) (1954); U.S. Pat. No. 4,660,577 to Sensabaugh, Jr. et al.; U.S. Pat. No. 5,387,416 to White et al. and U.S. Pat. No. 7,025,066 to Lawson et al.; US Patent Appl. Pub. Nos. 2006/0037623 to Lawrence, Jr. and 2008/0245377 to Marshall et al.; each of which is incorporated herein by reference. Exemplary Nicotiana species include N. tabacum, N. rustica, N. alata, N. arentsii, N. excelsior, N. forgetiana, N. glauca, N. glutinosa, N. gossei, N. kawakamii, N. knightiana, N. langsdorffi, N. otophora, N. setchelli, N. sylvestris, N. tomentosa, N. tomentosiformis, N. undulata, N. x sanderae, N. africana, N. amplexicaulis, N. benavidesii, N. bonariensis, N. debneyi, N. longiflora, N. maritina, N. megalosiphon, N. occidentalis, N. paniculata, N. plumbaginifolia, N. raimondii, N. rosulata, N. simulans, N. stocktonii, N. suaveolens, N. umbratica, N. velutina, N. wigandioides, N. acaulis, N. acuminata, N. attenuata, N. benthamiana, N. cavicola, N. clevelandii, N. cordifolia, N. corymbosa, N. fragrans, N. goodspeedii, N. linearis, N. miersii, N. nudicaulis, N. obtusifolia, N. occidentalis subsp. Hersperis, N. pauciflora, N. petunioides, N. quadrivalvis, N. repanda, N. rotundifolia, N. solanifolia, and N. spegazzinii

Nicotiana species can be derived using genetic-modification or crossbreeding techniques (e.g., tobacco plants can be genetically engineered or crossbred to increase or decrease production of components, characteristics or attributes). See, for example, the types of genetic modifications of plants set forth in U.S. Pat. No. 5,539,093 to Fitzmaurice et al.; U.S. Pat. No. 5,668,295 to Wahab et al.; U.S. Pat. No. 5,705,624 to Fitzmaurice et al.; U.S. Pat. No. 5,844,119 to Weigl; U.S. Pat. No. 6,730,832 to Dominguez et al.; U.S. Pat. No. 7,173,170 to Liu et al.; U.S. Pat. No. 7,208,659 to Colliver et al. and U.S. Pat. No. 7,230,160 to Benning et al.; US Patent Appl. Pub. No. 2006/0236434 to Conkling et al.; and PCT WO 2008/103935 to Nielsen et al. See, also, the types of tobaccos that are set forth in U.S. Pat. No. 4,660,577 to Sensabaugh, Jr. et al.; U.S. Pat. No. 5,387,416 to White et al.; and U.S. Pat. No. 6,730,832 to Dominguez et al., each of which is incorporated herein by reference. Most preferably, the tobacco materials are those that have been appropriately cured and aged. Especially preferred techniques and conditions for curing flue-cured tobacco are set forth in Nestor et al., Beitrage Tabakforsch. Int., 20 (2003) 467-475 and U.S. Pat. No. 6,895,974 to Peele, which are incorporated herein by reference. Representative techniques and conditions for air curing tobacco are set forth in Roton et al., Beitrage Tabakforsch. Int., 21 (2005) 305-320 and Staaf et al., Beitrage Tabakforsch. Int., 21 (2005) 321-330, which are incorporated herein by reference. Certain types of unusual or rare tobaccos can be sun cured. Manners and methods for improving the smoking quality of Oriental tobaccos are set forth in U.S. Pat. No. 7,025,066 to Lawson et al., which is incorporated herein by reference. Representative Oriental tobaccos include katerini, prelip, komotini, xanthi and yambol tobaccos. Tobacco compositions including dark air cured tobacco are set forth in US Patent Appl. Pub. No. 2008/0245377 to Marshall et al., which is incorporated herein by reference. See also, types of tobacco as set forth, for example, in US Patent Appl. Pub. No. 2011/0247640 to Beeson et al., which is incorporated herein by reference.

The Nicotiana species can be selected for the content of various compounds that are present therein. For example, in certain embodiments, plants of the Nicotiana species (e.g., Galpao commun tobacco) are specifically grown for their abundance of leaf surface compounds. In certain embodiments, plants of the Nicotiana species are specifically grown for their relatively low levels of certain undesired compounds (e.g., asparagine). Tobacco plants can be grown in greenhouses, growth chambers, or outdoors in fields, or grown hydroponically.

The means by which probiotics are applied to the tobacco plant can vary. Certain methods to treat plants with microorganisms which could be used, or modified for use, in the present invention are provided in U.S. Pat. No. 4,140,136 to Geiss et al.; U.S. Pat. No. 4,151,848 to Newton et al.; U.S. Pat. No. 4,308,877 to Mattina et al.; U.S. Pat. No. 4,476,881 to Gravely et al.; U.S. Pat. No. 4,556,073 to Gravely et al.; U.S. Pat. No. 4,557,280 to Gravely et al.; U.S. Pat. No. 4,566,469 to Semp et al.; U.S. Pat. No. 5,372,149 to Roth et al.; U.S. Pat. No. 7,549,425 to Koga et al.; U.S. Pat. No. 7,549,426 to Koga et al.; and U.S. Pat. No. 7,556,046 to Koga et al., all of which are incorporated herein by reference.

The method of application of probiotics as disclosed herein will often depend, at least in part, on the stage of the tobacco plant. For example, in certain embodiments, the one or more probiotics are applied to a tobacco seed prior to planting. In such embodiments, the one or more probiotics can be applied in the form of a seed treatment or coating. For example, the seeds can be dipped in probiotic solution, soaked in probiotic solution, or sprayed with probiotic solution. In certain embodiments, the one or more probiotics are applied to a tobacco in seedling or unharvested (live) plant form. In such embodiments, spray application of probiotics can be used (e.g., using a hydraulic boom sprayer, air blast sprayer, fogger, or aerial sprayer), although the method of probiotic application is not limited thereto.

Although it may be advantageous to apply the one or more probiotics while the tobacco plant is still in living form, it is also possible in some embodiments to apply probiotics following harvesting of the tobacco plants. Such application can occur at any time following harvest, including immediately following harvest, prior to or following post-harvest processing (e.g., drying, curing, and/or physical processing of the plant), or at any stage in between. The application of probiotics can be done at one stage in the plant life cycle, or can be conducted at two or more stages.

It can be advantageous, in some embodiments, to apply the probiotics in liquid form (e.g., as a solution, dispersion, or suspension). The liquid with which the probiotics is mixed can vary, but generally, the liquid will comprise water. In some other embodiments, the one or more probiotics can be applied dry, such as in granule or dust form. The concentration and amount of the probiotic used can vary. For example, in some embodiments, probiotic is applied to plants (e.g., living plants) in a solution comprising between about 1×10⁵ colony forming units (CFU)/mL and about 1×10¹⁰ CFU/mL (e.g., about 2×10⁶ CFU/mL). CFU provides a measurement of viable (living) cells in the probiotic sample.

In certain embodiments, other components can be applied to the plant with the probiotics. Such components can be added within the same formulation (e.g., solution, dispersion, suspension, or dry form) or can be applied to the tobacco in a separate formulation. For example, in some embodiments, one or more surfactants are applied to the tobacco with the probiotics. The surfactants can be, for example, non-ionic surfactants. Various surfactants can be used, including, but not limited to, polysorbate surfactants, such as polysorbate 20 (Tween-20®) and polysorbate 80 (Tween-80®) and poly(ethylene glycol)-based surfactants, such as Triton™ X Series surfactants Other reagents for helping the probiotic coat the tobacco effectively can include various sugars, plant extracts (e.g., yucca extracts, seaweed extracts), and derivatives thereof.

The whole tobacco plant, or certain parts or portions of the plant of the Nicotiana species can be used and/or treated as provided herein. For example, virtually all of the plant (e.g., the whole plant) can be harvested and employed as such. Alternatively, various parts or pieces of the plant can be harvested or separated for treatment after harvest. For example, the flower, leaves, stem, stalk, roots, seeds, and various combinations thereof, can be isolated for use or further treatment.

The post-harvest processing of the plant or portion thereof can vary. After harvest, the plant, or portion thereof, can be used in a green form (e.g., the plant or portion thereof can be used without being subjected to any curing process). For example, the plant or portion thereof can be used without being subjected to significant storage, handling or processing conditions. In certain situations, it is advantageous for the plant or portion thereof be used virtually immediately after harvest. Alternatively, for example, a plant or portion thereof in green form can be refrigerated or frozen for later use, freeze dried, subjected to irradiation, yellowed, dried, cured (e.g., using air drying techniques or techniques that employ application of heat), heated or cooked (e.g., roasted, fried or boiled), or otherwise subjected to storage or treatment for later use.

The harvested plant or portion thereof can be physically processed. The plant or portion thereof can be separated into individual parts or pieces (e.g., the leaves can be removed from the stems, and/or the stems and leaves can be removed from the stalk). The harvested plant or individual parts or pieces can be further subdivided into parts or pieces (e.g., the leaves can be shredded, cut, comminuted, pulverized, milled or ground into pieces or parts that can be characterized as filler-type pieces, granules, particulates or fine powders). The tobacco material can have the form of processed tobacco parts or pieces, cured and aged tobacco in essentially natural lamina and/or stem form, a tobacco extract, extracted tobacco pulp (e.g., using water as a solvent), or a mixture of the foregoing (e.g., a mixture that combines extracted tobacco pulp with granulated cured and aged natural tobacco lamina). The tobacco that is used for the tobacco product most preferably includes tobacco lamina, or a tobacco lamina and stem mixture. Portions of the tobaccos within the tobacco product may have processed forms, such as processed tobacco stems (e.g., cut-rolled stems, cut-rolled-expanded stems or cut-puffed stems), or volume expanded tobacco (e.g., puffed tobacco, such as dry ice expanded tobacco (DIET)). See, for example, the tobacco expansion processes set forth in U.S. Pat. No. 4,340,073 to de la Burde et al.; U.S. Pat. No. 5,259,403 to Guy et al.; and U.S. Pat. No. 5,908,032 to Poindexter, et al.; and U.S. Pat. No. 7,556,047 to Poindexter, et al., all of which are incorporated by reference. In addition, the tobacco product optionally may incorporate tobacco that has been fermented. See, also, the types of tobacco processing techniques set forth in PCT WO 05/063060 to Atchley et al., which is incorporated herein by reference.

The manner by which the tobacco is provided in such forms can vary. The plant, or parts thereof, can be subjected to external forces or pressure (e.g., by being pressed or subjected to roll treatment). When carrying out such processing conditions, the plant or portion thereof can have a moisture content that approximates its natural moisture content (e.g., its moisture content immediately upon harvest), a moisture content achieved by adding moisture to the plant or portion thereof, or a moisture content that results from the drying of the plant or portion thereof. For example, powdered, pulverized, ground or milled pieces of plants or portions thereof can have moisture contents of less than about 25 weight percent, often less than about 20 weight percent, and frequently less than about 15 weight percent. Tobacco parts or pieces can be comminuted, ground or pulverized into a powder type of form using equipment and techniques for grinding, milling, or the like. Most preferably, the tobacco is relatively dry in form during grinding or milling, using equipment such as hammer mills, cutter heads, air control mills, or the like. For example, tobacco parts or pieces may be ground or milled when the moisture content thereof is less than about 15 weight percent to less than about 5 weight percent.

Tobacco compositions intended to be used in a smokable or smokeless form may incorporate a single type of tobacco (e.g., in a so-called “straight grade” form). For example, the tobacco within a tobacco composition may be composed solely of flue-cured tobacco (e.g., all of the tobacco may be composed, or derived from, either flue-cured tobacco lamina or a mixture of flue-cured tobacco lamina and flue-cured tobacco stem. The tobacco within a tobacco composition also may have a so-called “blended” form. For example, the tobacco within a tobacco composition of the present invention may include a mixture of parts or pieces of flue-cured, burley (e.g., Malawi burley tobacco) and Oriental tobaccos (e.g., as tobacco composed of, or derived from, tobacco lamina, or a mixture of tobacco lamina and tobacco stem). For example, a representative blend may incorporate about 30 to about 70 parts burley tobacco (e.g., lamina, or lamina and stem), and about 30 to about 70 parts flue cured tobacco (e.g., stem, lamina, or lamina and stem) on a dry weight basis. Other exemplary tobacco blends incorporate about 75 parts flue-cured tobacco, about 15 parts burley tobacco, and about 10 parts Oriental tobacco; or about 65 parts flue-cured tobacco, about 25 parts burley tobacco, and about 10 parts Oriental tobacco; or about 65 parts flue-cured tobacco, about 10 parts burley tobacco, and about 25 parts Oriental tobacco; on a dry weight basis. Other exemplary tobacco blends incorporate about 20 to about 30 parts Oriental tobacco and about 70 to about 80 parts flue-cured tobacco.

Tobacco that has been treated according to the present disclosure can, in certain embodiments, be subsequently extracted. Various extraction techniques can be used. See, for example, the extraction processes described in US Pat. Appl. Pub. No. 2011/0247640 to Beeson et al., which is incorporated herein by reference. Other exemplary techniques for extracting components of tobacco are described in U.S. Pat. No. 4,144,895 to Fiore; U.S. Pat. No. 4,150,677 to Osborne, Jr. et al.; U.S. Pat. No. 4,267,847 to Reid; U.S. Pat. No. 4,289,147 to Wildman et al.; U.S. Pat. No. 4,351,346 to Brummer et al.; U.S. Pat. No. 4,359,059 to Brummer et al.; U.S. Pat. No. 4,506,682 to Muller; U.S. Pat. No. 4,589,428 to Keritsis; U.S. Pat. No. 4,605,016 to Soga et al.; U.S. Pat. No. 4,716,911 to Poulose et al.; U.S. Pat. No. 4,727,889 to Niven, Jr. et al.; U.S. Pat. No. 4,887,618 to Bernasek et al.; U.S. Pat. No. 4,941,484 to Clapp et al.; U.S. Pat. No. 4,967,771 to Fagg et al.; U.S. Pat. No. 4,986,286 to Roberts et al.; U.S. Pat. No. 5,005,593 to Fagg et al.; U.S. Pat. No. 5,018,540 to Grubbs et al.; U.S. Pat. No. 5,060,669 to White et al.; U.S. Pat. No. 5,065,775 to Fagg; U.S. Pat. No. 5,074,319 to White et al.; U.S. Pat. No. 5,099,862 to White et al.; U.S. Pat. No. 5,121,757 to White et al.; U.S. Pat. No. 5,131,414 to Fagg; U.S. Pat. No. 5,131,415 to Munoz et al.; U.S. Pat. No. 5,148,819 to Fagg; U.S. Pat. No. 5,197,494 to Kramer; U.S. Pat. No. 5,230,354 to Smith et al.; U.S. Pat. No. 5,234,008 to Fagg; U.S. Pat. No. 5,243,999 to Smith; U.S. Pat. No. 5,301,694 to Raymond et al.; U.S. Pat. No. 5,318,050 to Gonzalez-Parra et al.; U.S. Pat. No. 5,343,879 to Teague; U.S. Pat. No. 5,360,022 to Newton; U.S. Pat. No. 5,435,325 to Clapp et al.; U.S. Pat. No. 5,445,169 to Brinkley et al.; U.S. Pat. No. 6,131,584 to Lauterbach; U.S. Pat. No. 6,298,859 to Kierulff et al.; U.S. Pat. No. 6,772,767 to Mua et al.; and U.S. Pat. No. 7,337,782 to Thompson, all of which are incorporated by reference herein.

The tobacco materials discussed in the present invention can further be treated and/or processed in other ways before, after, or during the probiotic treatment described herein. For example, if desired, the tobacco materials can be irradiated, pasteurized, or otherwise subjected to controlled heat treatment. Such treatment processes are detailed, for example, in US Pat. Pub. No. 2009/0025738 to Mua et al., which is incorporated herein by reference. In certain embodiments, tobacco materials can be treated with water and an additive capable of inhibiting reaction of asparagine to form acrylamide upon heating of the tobacco material (e.g., an additive selected from the group consisting of lysine, glycine, histidine, alanine, methionine, glutamic acid, aspartic acid, proline, phenylalanine, valine, arginine, compositions incorporating di- and trivalent cations, asparaginase, certain non-reducing saccharides, certain reducing agents, phenolic compounds, certain compounds having at least one free thiol group or functionality, oxidizing agents, oxidation catalysts, natural plant extracts (e.g., rosemary extract), and combinations thereof), and combinations thereof. See, for example, the types of treatment processes described in US Pat. Pub. Nos. 2010/0300463 and 2011/0048434 to Chen et al., and U.S. patent application Ser. No. 13/228,912, filed Sep. 9, 2011, which are all incorporated herein by reference. In certain embodiments, this type of treatment is useful where the original tobacco material is subjected to heat in the extraction and/or distillation process previously described. Although this type of treatment can be used in combination with the probiotic treatment of the invention, it is noted that it may not be required, as probiotic treatment can, in some embodiments, reduce acrylamide levels to a sufficiently low level on its own.

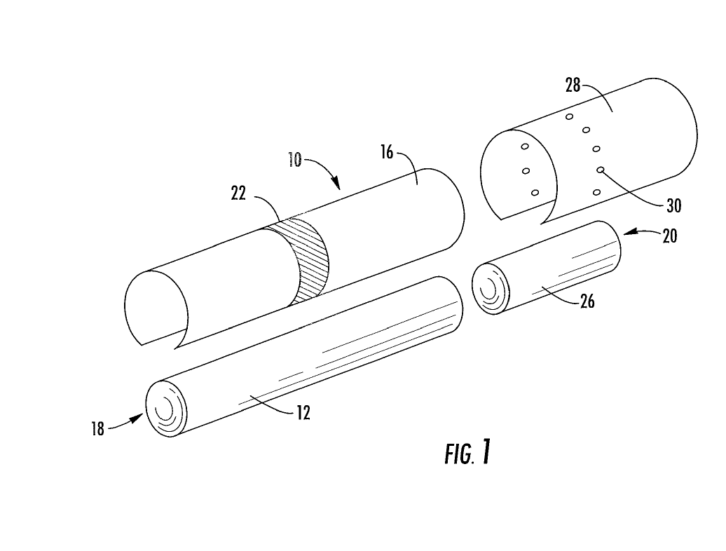

The probiotic-treated tobacco can be incorporated within various types of tobacco products according to the present invention. For example, in some embodiments, the invention provides smoking articles, such as cigarettes, that comprise a probiotic-treated tobacco material. Referring to FIG. 1, there is shown a smoking article 10 in the form of a cigarette and possessing certain representative components of a smoking article of the present invention. The cigarette 10 includes a generally cylindrical rod 12 of a charge or roll of smokable filler material (e.g., about 0.3 to about 1.0 g of smokable filler material such as probiotic-treated tobacco material) contained in a circumscribing wrapping material 16. The rod 12 is conventionally referred to as a “tobacco rod.” The ends of the tobacco rod 12 are open to expose the smokable filler material. The cigarette 10 is shown as having one optional band 22 (e.g., a printed coating including a film-forming agent, such as starch, ethylcellulose, or sodium alginate) applied to the wrapping material 16, and that band circumscribes the cigarette rod in a direction transverse to the longitudinal axis of the cigarette. That is, the band 22 provides a cross-directional region relative to the longitudinal axis of the cigarette. The band 22 can be printed on the inner surface of the wrapping material (i.e., facing the smokable filler material), or less preferably, on the outer surface of the wrapping material. Although the cigarette can possess a wrapping material having one optional band, the cigarette also can possess wrapping material having further optional spaced bands numbering two, three, or more.

At one end of the tobacco rod 12 is the lighting end 18, and at the mouth end 20 is positioned a filter element 26. The filter element 26 positioned adjacent one end of the tobacco rod 12 such that the filter element and tobacco rod are axially aligned in an end-to-end relationship, preferably abutting one another. Filter element 26 may have a generally cylindrical shape, and the diameter thereof may be essentially equal to the diameter of the tobacco rod. The ends of the filter element 26 permit the passage of air and smoke therethrough.

A ventilated or air diluted smoking article can be provided with an optional air dilution means, such as a series of perforations 30, each of which extend through the plug wrap 28. The optional perforations 30 can be made by various techniques known to those of ordinary skill in the art, such as laser perforation techniques. Alternatively, so-called off-line air dilution techniques can be used (e.g., through the use of porous paper plug wrap and pre-perforated tipping paper). The filter element 26 is circumscribed along its outer circumference or longitudinal periphery by a layer of outer plug wrap 28. During use, the smoker lights the lighting end 18 of the cigarette 10 using a match or cigarette lighter. As such, the smokable material 12 begins to burn. The mouth end 20 of the cigarette 10 is placed in the lips of the smoker. Thermal decomposition products (e.g., components of tobacco smoke) generated by the burning smokable material 12 are drawn through the cigarette 10, through the filter element 26, and into the mouth of the smoker.

In certain embodiments, according to the invention, a smoking article comprises tobacco that has been treated with probiotics. The tobacco within the smoking article can, in some embodiments, comprise only such probiotic-treated tobacco or can contain varying amounts of probiotic-treated tobacco in combination with other tobacco materials. For example, the probiotic-treated tobacco can be present in an amount of about 25% or more, about 50% or more, about 75% or more, about 80% or more, about 85% or more, about 90% or more, about 95% or more, or about 100% based on the weight of all tobacco material in the smoking article.

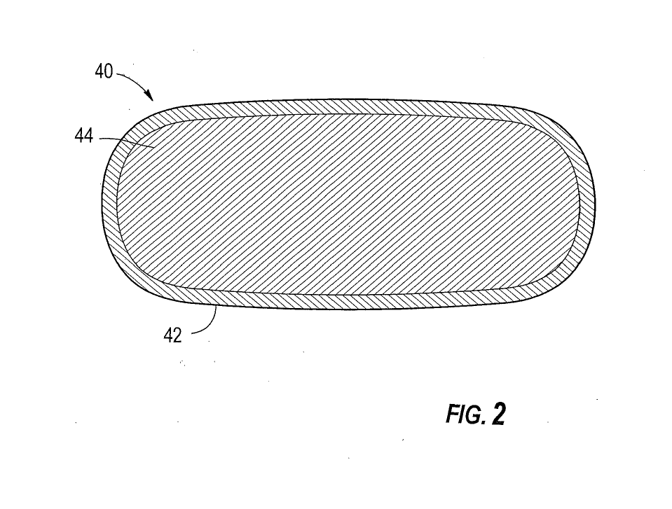

Referring to FIG. 2, a representative snus type of tobacco product comprising the probiotic-treated tobacco of the present invention is shown. In particular, FIG. 2 illustrates a smokeless tobacco product 40 having a water-permeable outer pouch 42 containing a smokeless tobacco composition 44, wherein the tobacco composition includes a shredded or particulate tobacco material that has been treated with one or more probiotics. Further additives can be admixed with, or otherwise incorporated within, the smokeless tobacco compositions according to the invention. The additives can be artificial, or can be obtained or derived from herbal or biological sources. Exemplary types of additives include salts (e.g., sodium chloride, potassium chloride, sodium citrate, potassium citrate, sodium acetate, potassium acetate, and the like), natural sweeteners (e.g., fructose, sucrose, glucose, maltose, vanillin, ethylvanillin glucoside, mannose, galactose, lactose, and the like), artificial sweeteners (e.g., sucralose, saccharin, aspartame, acesulfame K, neotame and the like), organic and inorganic fillers (e.g., grains, processed grains, puffed grains, maltodextrin, dextrose, calcium carbonate, calcium phosphate, corn starch, lactose, manitol, xylitol, sorbitol, finely divided cellulose, and the like), binders (e.g., povidone, sodium carboxymethylcellulose and other modified cellulosic types of binders, sodium alginate, xanthan gum, starch-based binders, gum arabic, lecithin, and the like), pH adjusters or buffering agents (e.g., metal hydroxides, preferably alkali metal hydroxides such as sodium hydroxide and potassium hydroxide, and other alkali metal buffers such as metal carbonates, preferably potassium carbonate or sodium carbonate, or metal bicarbonates such as sodium bicarbonate, and the like), colorants (e.g., dyes and pigments, including caramel coloring and titanium dioxide, and the like), humectants (e.g., glycerin, propylene glycol, and the like), oral care additives (e.g., thyme oil, eucalyptus oil, and zinc), preservatives (e.g., potassium sorbate, and the like), syrups (e.g., honey, high fructose corn syrup, and the like), disintegration aids (e.g., microcrystalline cellulose, croscarmellose sodium, crospovidone, sodium starch glycolate, pregelatinized corn starch, and the like), flavorant and flavoring mixtures, antioxidants, and mixtures thereof. If desired, the additive can be microencapsulated as set forth in US Patent Appl. Pub. No. 2008/0029110 to Dube et al., which is incorporated by reference herein. In addition, exemplary encapsulated additives are described, for example, in WO 2010/132444 A2 to Atchley, which has been previously incorporated by reference herein.

The following examples are provided to illustrate further the present invention, but should not be construed as limiting the scope thereof. Unless otherwise noted, all parts and percentages are by weight.

### Experimental

The present invention is more fully illustrated by the following examples, which are set forth to illustrate the present invention and are not to be construed as limiting thereof. In the following examples, g means gram, L means liter, mL means milliliter, and Da means daltons. All weight percentages are expressed on a dry basis, meaning excluding water content, unless otherwise indicated.

### EXAMPLE 1

### Evaluation of Burley Tobacco Following Treatment with Probiotic Bacteria

Burley tobacco is treated prior to harvest with solutions containing probiotic bacteria, available over the counter as a digestive support product. Ten live burley tobacco plants are treated with one gallon of solution containing 60×10⁹ live bacteria cells per gallon (“Senior Probiotic,” from CVS/Pharmacy®, comprising bifidobacterium bifidum, bifidobacterium breve, bifidobacterium longum, lactobacillus acidophilus, lactobacillus casei, lactobacillus helveticus, lactobacillus rhamnosus, lactobacillus plantarum, lactococcus lactis, and streptococcus thermophilus). Ten additional live burley tobacco plants are treated with one gallon of solution containing 60×10⁹ live bacteria cells per gallon (“Super Probiotic,” from Walgreens, comprising lactobacillus acidophilus and bifidobacterium lactis).

The treated burley tobacco is harvested and subjected to curing in standard conditions. The tobacco is stalk cut and air-cured, with the upper, middle, and lower leaves grouped and segregated at the end of the cure. About 15 g leaf from tip, middle, and lower part of the plant are ground and analyzed.

The treated, cured, and segregated tobacco is analyzed for comparative levels of 63 different compounds, as well as amino acid levels and polyphenols. Results show a reduction in the levels of certain compounds following probiotic treatment, including amino acids and tobacco specific acids. For example, a significant decrease in asparagine, tryptophan, oxoproline, aspartic acid, malic acid, quinic acid, and glucose is observed. Specifically, the asparagine content from mid-section samples of untreated and treated burley tobacco samples are compared; the sample treated with “Senior Probiotic” from CVS/Pharmacy® has 35.27% asparagine content as compared with the untreated sample and the sample treated with “Super Probiotic” from Walgreens has 12.9% asparagine content as compared with the untreated sample. The levels of certain compounds increased, namely, xylitol, fructose, galactaric acid, myoinositol, and melibiose. Each of these compounds is present in the probiotic mixture as-purchased as a non-active ingredient.

Similar results are noted for treated and untreated burley tobacco samples taken from the tip parts of the plant and from the lugs.

### EXAMPLE 2

### Evaluation of TSNAs in Burley Tobacco Following Treatment with Probiotic Bacteria

Burley tobacco plants are treated with two different probiotic solutions, harvested, and cured as described in Example 1. About 15 g of leaf from the middle of the plant are ground and analyzed for tobacco-specific nitrosamines (TSNAs). As compared with the control, tobacco treated with “Super Probiotic” from Walgreens contains 95% NAT and 70% NNN. As compared with a control (untreated) tobacco, tobacco treated with Senior Probiotic from CVS/Pharmacy® contains 57% NAT and 43% NNN.

### EXAMPLE 3

### Evaluation of Acrylamide Content in Mainstream Smoke Produced by Burley Tobacco Following Treatment with Probiotic Bacteria

Burley tobacco plants are treated with two different probiotic solutions, harvested, and cured as described in Example 1. A portion of the middle stalk leaves of the treated tobacco plants are cut and made into cigarettes. The cigarettes are tested using a Ceruean SM 450 smoking machine (Cerulean, Linford Wood East, MK14 6LY, United Kingdom) under ISO conditions (a 35 mL puff volume, 2 second puff, and 60 second puff interval). Smoke is collected in each run on a 44 mm Cambridge smoke pad. To analyze the acrylamide content in the smoke produced from each cigarette, the smoke pads are soaked in methanol; water is added and an internal standard solution of ²H₃-acrylamide (CDN Isotopes, Ponte-Claire, Quebec H9R1H1, Canada) is added. The resulting extract is filtered and passed through an SFE cartridge (Bond Elute C18), Varian, Walnut Creek, Calif. 9 for sample cleanup.

The clean sample solutions are analyzed using an LC/MS/MS technique. HPLC separation is performed on two Gemini-NX 5u C18 150×2 mm columns with a guard cartridge C18 TWIN (Phenomex, Torrance, Calif.) in series, in isocratic mode using a solvent system of 5% methanol and 0.1% formic acid in water. The HPLC is a 1200 HPLC system (Agilent, Wilmington, Del.), with a flow rate of 0.3 mL/min and run at room temperature. The retention time observed for ²H₃-acrylamide is 3.65 minutes and for acrylamide, the retention time observed is 3.68 min.

Acrylamide is measured using an API LC/MS/MS system (AB Sciex, MA), with an atmospheric pressure ionization electrospray in positive ion mode MRM (multiple reaction monitoring). The conditions include a collision cell gas 8 L/h, curtain gas 20 L/h, ion source gas 1 50 L/h, ion source gas 2 50 L/h, ion spray voltage 5500V, temperature 400° C., declustering potential 30 V, entrance lens potential 6 V, collision cell voltage 21 V, collision cell exit voltage 6V. The parent ion for acrylamide is m/z=72 and for the daughter ion, m/z=55. For ²H₃-acrylamide, the parent is m/z=75 and for the daughter ion, m/z=58.

As compared with a cigarette comprising control (untreated), cigarettes comprising tobacco treated with “Super Probiotic” from Walgreens exhibit a 29% decrease in acrylamide content in the smoke produced therefrom. As compared with a cigarette comprising control (untreated), cigarettes comprising tobacco treated with “Super Probiotic” from CVS/Pharmacy® exhibit a 65% decrease in acrylamide content in the smoke produced therefrom.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed:

1. A method of modifying amino acid and tobacco-specific nitrosamine content in a tobacco material, comprising contacting a tobacco plant component with one or more probiotics.

2. The method of claim 1, wherein the tobacco plant component is selected from the group consisting of a tobacco seed, a tobacco seedling, an immature live plant, a mature live plant, a harvested plant, or a portion thereof.

3. The method of claim 1, wherein the one or more probiotics are selected from the group consisting of probiotic species of the genera bifidobacterium, lactobacillus, enterococcus, proionobacterium, bacillus, saccharomyces, streptococcus, and mixtures thereof.

4. The method of claim 1, wherein the one or more probiotics are selected from the group consisting of bifidobacterium adolescentis, bifidobacterium animalis, bifidobacterium bifidum, bifidobacterium breve, bifidobacterium infantis, bifidobacterium lactis, bifidobacterium longum, bifidobacterium pseudocatenulatum, bifidobacterium pseudolongum, bifidobacterium sp., bifidobacterium thermophilum, lactobacillus acidophilus, lactobacillus alimentarius, lactobacillus amylovorus lactobacillus bulgaricus, lactobacillus bifidus, lactobacillus brevis, lactobacillus casei, lactobacillus caucasicus, lactobacillus crispatus, lactobacillus curvatus, lactobacillus delbruckii, lactobacillus fermentum, lactobacillus gallinarum, lactobacillus gasseri, lactobacillus helveticus, lactobacillus johnsonii, lactobacillus lactis, lactobacillus leichmannii, lactobacillus paracasei, lactobacillus plantarum, lactobacillus reuteri, lactobacillus rhamnosus, lactobacillus salivarius, lactobacillus sp., lactobacillus sporogenes, lactococcus lactis, streptococcus cermoris, streptococcus faceium, streptococcus infantis, streptococcus thermophilus, enterococcus faceium, pediococcus acidilactici, staphylococcus thermophilus, staphylococcus carnosus, staphylococcus xylosus, saccharomyces boulardii, saccharomyces cerevisiae, saccharomyces boulardii, bacillus cereus var toyo, bacillus subtilis, bacillus coagulans, bacillus licheniformis, and mixtures thereof.

5. The method of claim 1, wherein the one or more probiotics comprise at least one probiotic selected from the genus bifidobacterium and at least one probiotic selected from the genus lactobacillus.

6. The method of claim 1, wherein the one or more probiotics comprise two or more probiotics selected from the genus bifidobacterium or two or more probiotics selected from the genus lactobacillus.

7. The method of claim 1, wherein the contacting step comprises applying the one or more probiotics in a solution, suspension, or dispersion in water.

8. The method of claim 1, wherein the asparagine content of the tobacco material following the contacting step is reduced by at least about 50% by weight.

9. The method of claim 1, wherein the tobacco plant component comprises flue-cured tobacco, burley tobacco, Oriental tobacco, or a mixture thereof.

10. The method of claim 1, further comprising incorporating the tobacco material into a smokeless tobacco product or a smoking article.

11. The method of claim 10, wherein the tobacco material is in the form of cut filler.

12. The method of claim 10, wherein the tobacco material is in the form of a tobacco blend.

13. The method of claim 10, wherein the smoking article, upon smoking, is characterized by an acrylamide content of mainstream smoke that is reduced relative to an untreated control smoking article.

14. The method of claim 13, wherein the amount of acrylamide reduction by weight in mainstream smoke is at least about 20% as compared to an untreated control smoking article.

15. The method of claim 13, wherein the amount of acrylamide reduction by weight in mainstream smoke is at least about 40% as compared to an untreated control smoking article.

16. A tobacco product in the form of a cigarette or a smokeless tobacco product prepared according to the method of claim 10.

17. A tobacco product in the form of a smoking article or a smokeless tobacco product, the tobacco product comprising a tobacco composition, wherein the tobacco composition comprises a probiotic-treated tobacco material.

18. The tobacco product of claim 17, in the form of a cigarette comprising a rod of smokable material circumscribed by a wrapping material and a filter attached to the rod at one end thereof, wherein the smokable material comprises a tobacco material pre-treated with one or more probiotics to decrease the content of asparagine.

19. The tobacco product of claim 18, wherein the smoking article, upon smoking, is characterized by an acrylamide content of mainstream smoke that is reduced relative to an untreated control smoking article.

20. The tobacco product of claim 19, wherein the amount of acrylamide reduction by weight in mainstream smoke is at least about 20% as compared to an untreated control smoking article.

21. The tobacco product of claim 20, wherein the amount of acrylamide reduction by weight in mainstream smoke is at least about 40% as compared to an untreated control smoking article.
